(19) United States
(12) Patent Application Publication
(10) Pub. No.: US 2026/0236040 A1
(43) Pub. Date: Aug. 13, 2026

(54) METHOD AND SYSTEM FOR COORDINATED CONTROL OF UNMANNED AERIAL VEHICLE (UAV) SWARM BASED ON COMMUNICATION INFORMATION COMPLETION

(71) Applicant: TONGJI UNIVERSITY, Shanghai (CN)

(72) Inventors: Bin HE, Shanghai (CN); Jie CHEN, Shanghai (CN); Bin CHENG, Shanghai (CN); Zhuohui ZHANG, Ningbo (CN); Chenlong LIU, Luoyang (CN)

(73) Assignee: TONGJI UNIVERSITY, Shanghai (CN)

(21) Appl. No.: 19/397,816

(22) Filed: Nov. 21, 2025

(30) Foreign Application Priority Data
Feb. 7, 2025 (CN) 202510136889.4

(51) Int. Cl. G05D 1/69; B64U 20/80; G05D 1/622; G05D 101/15

(52) U.S. Cl. CPC G05D 1/69; B64U 20/80; G05D 1/622; B64U 2201/102; G05D 2101/15

(57) ABSTRACT

A method and a system for coordinated control of a UAV swarm based on communication information completion are provided. The method includes: obtaining an information weight based on a local observation and information obtained from other UAVs through an information-level weighting network; obtaining weighted information of each UAV, and generating a global state through an adaptive generation network; obtaining a global action-value function by integrating a local action-value function of each UAV through a mixing network based on the global state and the local action-value function of the UAV; in a distributed execution phase, obtaining, by each UAV, the local action-value function of the UAV based on the local observation and the information weight through a Transformer-based decoder, and performing coordinated decision-making through a policy network.

### CROSS-REFERENCE TO RELATED APPLICATIONS

This application claims priority to the Chinese Patent Application No. 202510136889.4, filed on Feb. 7, 2025, the contents of which are hereby incorporated by reference.

### TECHNICAL FIELD

The present disclosure relates to a technical field of UAV coordinated control, and in particular to a method and a system for coordinated control of a UAV swarm based on communication information completion.

### BACKGROUND

In recent years, multi-UAV reinforcement learning has received widespread attention due to its potential for modeling and solving complex cooperative tasks in practical applications. Unlike single-UAV reinforcement learning, multi-UAV reinforcement learning faces a challenge of promoting UAV collaboration to achieve common goals. An added dimension of collaboration introduces many difficulties, as neither centralized nor distributed approaches can effectively address non-stationarity arising from concurrent learning of joint policies and scalability issues that worsen with the increase in the count of UAVs. Existing multi-UAV reinforcement learning algorithms primarily rely on a paradigm of Centralized Training with Decentralized Execution (CTDE). However, the paradigm has certain limitations. In centralized training, an assumption that UAVs can access a global state is an idealized scenario. However, in distributed execution, decision-making of each UAV relies solely on its local observation. The limitations may affect decision-making and collaborative capabilities of the UAV.

To enhance the decision-making and collaborative capabilities of UAVs, increased attention has been directed toward integrating communication mechanisms into a Multi-Agent Reinforcement Learning (MARL) framework. By allowing UAVs to exchange information such as local observations, beliefs, or intentions, inference of the global state and coordinated decision-making can be improved. However, existing approaches face three main problems. Firstly, communication models of the existing approaches lack accuracy. These communication models typically predefine communication patterns and communicate through broadcasting or peer-to-peer mechanisms. Although the approaches specify when the UAVs should communicate and with whom, the approaches do not delve into communication at an information level. Secondly, many approaches suffer from low computational efficiency. The communication models and a policy network can only be jointly learned through sparse reinforcement learning rewards, without decoupling the communication module from a training process, which leads to reduced training efficiency. Finally, communication is usually limited to a distributed execution phase. In a centralized training process, the approaches still rely on access to the global state and fail to bridge a gap between training and execution through communication. Therefore, there is currently a lack of a plug-and-play multi-UAV reinforcement learning method capable of information-level modeling to solve the problems.

### SUMMARY

One or more embodiments of the present disclosure provide a method for coordinated control of an unmanned aerial vehicle (UAV) swarm based on communication information completion. The method comprises: obtaining, by each UAV, a local observation of the UAV from an environment, wherein the local observation is obtained in real time through a sensor disposed on the UAV; in a centralized training phase, obtaining an information weight based on the local observation through an information-level weighting network; obtaining weighted information of each UAV based on the information weight; generating a global state through an adaptive generation network based on the weighted information of each UAV; obtaining a global action-value function by integrating a local action-value function of each UAV through a mixing network based on the global state and the local action-value function of the UAV; wherein the local action-value function is calculated by each UAV based on the local observation through an independent Q-network; the UAV swarm interacting with the environment to obtain a reward based on the global action-value function; updating a parameter of the mixing network based on the reward through a first loss function; updating a parameter of the adaptive generation network and a parameter of the information-level weighting network based on the information weight, the local observation, and the global state by a generative adversarial network loss function; re-obtaining an information weight according to an updated information-level weighting network, and transmitting the information weight to each UAV; and in a distributed execution phase, obtaining, by each UAV, the local action-value function of the UAV based on the local observation and the information weight through a Transformer-based decoder, and performing coordinated decision-making based on the local action-value function through a policy network to guide the UAV swarm to execute a corresponding action.

One or more embodiments of the present disclosure provide a system for coordinated control of a UAV swarm based on communication information completion, comprising: an information-level weighting network configured to process a local observation of each UAV and information of other UAVs to generate an information weight; an adaptive generation network including an information completion network and a global discriminator network, wherein the information completion network is connected to the information-level weighting network and generates a global state through an encoder-decoder architecture, and the global discriminator network is configured to determine an authenticity of the global state; a mixing network configured to integrate local action-value functions of UAVs and generate a global action-value function through an additive structure; a Transformer-based decoder configured to calculate a local action-value function of each UAV based on the local observation and the information weight in a distributed execution phase; a policy network configured to generate a final execution action according to the local action-value functions and coordinated decision-making; a loss function module including a first loss function and a generative adversarial network loss function, configured to update parameters of the mixing network, the adaptive generation network, and the information-level weighting network; a communication module configured to transmit weighted information and decision information between the UAVs; and an environment interaction module configured to simulate an interaction process between the UAVs and the environment and collect a reward signal.

### BRIEF DESCRIPTION OF THE DRAWINGS

FIG. 1 is a schematic diagram illustrating a plug-and-play module according to some embodiments of the present disclosure;

FIG. 2 is a schematic diagram illustrating an adaptive generation network according to some embodiments of the present disclosure;

FIG. 3 is a system relationship diagram illustrating a plug-and-play module and a method according to some embodiments of the present disclosure; and

FIG. 4 is a flowchart illustrating an exemplary process of plug-and-play multi-UAV reinforcement learning for communication information completion according to some embodiments of the present disclosure.

### DETAILED DESCRIPTION

To more clearly illustrate the technical solutions in the embodiments of the present disclosure, the drawings used in the description of the embodiments will be briefly introduced below. Obviously, drawings described below are only some examples or embodiments of the present disclosure. Those skilled in the art, without further creative efforts, may apply the present disclosure to other similar scenarios according to these drawings.

Some embodiments of the present disclosure provide a multi-UAV reinforcement learning method for communication information completion. The process is applied to multi-UAV collaboration, executed by a processor, and specifically includes following operations 1 to 4.

The processor is configured in a system for coordinated control of a UAV swarm based on communication information completion.

In the operation 1, each UAV may obtain a local observation of the UAV from an environment, where the local observation may be obtained in real time through a sensor disposed on the UAV.

The local observation refers to a perception result of the UAV on a state and information in a limited area around the UAV. For example, the local observation includes a position, a speed, an attitude, and a battery level of the UAV, a position and distance information of a nearby obstacle, and perceived environment data such as local illumination and texture.

In some embodiments, the UAV obtains the local observation from the environment through the sensor.

For example, the sensor may include a camera, a lidar, an ultrasonic range finder, a global positioning system (GPS) module, an inertial measurement unit (IMU), etc.

In the operation 2, in a centralized training phase, an information weight may be obtained based on the local observation through an information-level weighting network; weighted information of each UAV may be obtained based on the information weight; a global state may be generated through an adaptive generation network based on the weighted information of each UAV; a global action-value function may be obtained by integrating a local action-value function of each UAV through a mixing network based on the global state and the local action-value function of the UAV; wherein the local action-value function is calculated by each UAV based on the local observation through an independent Q-network; the UAV swarm may interact with the environment to obtain a reward based on the global action-value function; a parameter of the mixing network may be updated based on the reward through a first loss function; a parameter of the adaptive generation network and a parameter of the information-level weighting network may be updated based on the information weight, the local observation, and the global state by a generative adversarial network loss function.

The centralized training phase refers to a period in a multi-UAV reinforcement learning system where data of all UAVs is collected to a central processing unit for unified model learning and parameter optimization.

The information weight refers to a quantitative indicator assigned to a specific information source or information segment in an information fusion or decision-making process. The information weight is used to reflect reliability, relevance, or importance of the specific information source or information segment in a current context. For example, observation information of a certain UAV may be assigned a higher information weight due to high clarity or strong timeliness. More descriptions regarding the information weight may be found in the related descriptions below.

In some embodiments, the processor obtains the weighted information of each UAV based on the information weight.

The weighted information refers to a comprehensive information representation obtained by combining or fusing a plurality of information sources or information segments according to respective information weights. For example, the processor performs weighted averaging or weighted summation on the local observation of a certain UAV and information of other UAVs according to respective information weights to obtain a comprehensive information.

In some embodiments, the processor generates the global state through the adaptive generation network based on the weighted information of each UAV.

The global state refers to a comprehensive and holistic description of all UAVs and an environment in which the UAVs are located in a multi-UAV system. For example, the global state includes a coordinated position, a speed, and an attitude of the entire UAV swarm, an overall environment obstacle distribution map, a task completion progress, etc.

In some embodiments, the processor integrates local action-value functions of UAVs in the entire UAV swarm through the mixing network based on the global state and the local action-value functions of the UAVs to obtain the global action-value function. The local action-value function of each UAV is calculated by the UAV through the independent Q-network based on the local observation of the UAV.

The local action-value function refers to an evaluation function in reinforcement learning for an expected cumulative reward that the UAV obtains by executing a specific action under a specific local observation.

The global action-value function refers to a function in multi-agent reinforcement learning for evaluating an expected cumulative reward that the UAV swarm obtains as a whole by executing a set of coordinated actions in a specific global state.

In some embodiments, the process calculates the local action-value function (Q value) of each UAV through the independent Q-network based on the local observation of the UAV.

More descriptions regarding the mixing network may be found in the related descriptions below.

The Q-network refers to a deep learning-based reinforcement learning network for estimating a Q value (i.e., an expected cumulative reward) of executing a specific action in a given state.

In some embodiments, a reward is obtained through interaction between the UAV swarm and the environment based on the global action-value function.

The reward refers to an immediate feedback signal obtained by the UAV swarm from the environment after interacting with the environment and executing an action, which is used to measure the quality of the action. For example, the UAV swarm obtains a positive reward when performing positive behaviors such as successfully avoiding an obstacle, completing a task objective, and maintaining formation stability. The UAV swarm obtains a negative reward when performing negative behaviors such as collision and deviation from a flight path.

In some embodiments, the processor updates the parameter of the mixing network through the first loss function based on the reward.

The first loss function refers to a metric function used in machine learning and reinforcement learning to quantify a difference between a model predicted value and a true target value. For example, the first loss function includes a Q-value prediction error loss function for updating the parameter of the mixing network.

In some embodiments, the processor updates the parameter of the adaptive generation network and the parameter of the information-level weighting network through the generative adversarial network loss function based on the information weight, the local observation, and the global state.

In the operation 3, an information weight may be re-obtained according to an updated information-level weighting network, and the information weight may be transmitted to each UAV.

In some embodiments, the parameter of the information-level weighting network is optimized through the generative adversarial network loss function. When the processor inputs a latest local observation into the updated information-level weighting network, a more accurate information weight that better reflects a current environment and task requirements is output.

In some embodiments, the processor broadcasts or point-to-point transmits the updated information weight to each UAV through a wireless communication network (e.g., Wi-Fi, 4G/5G).

As another example, in addition to wireless communication, the processor may also transmit through an optical fiber link or satellite communication. The UAV receives and stores the information weight for use in the distributed execution phase.

In the operation 4, in a distributed execution phase, the local action-value function of each UAV may be obtained by the UAV based on the local observation and the information weight through a Transformer-based decoder, and coordinated decision-making may be performed based on the local action-value function through a policy network to guide the UAV swarm to execute a corresponding action.

The distributed execution phase refers to a period in the multi-UAV reinforcement learning system where each UAV independently makes decisions and executes actions based on its local information.

In some embodiments, in the distributed execution phase, each UAV obtains its local action-value function through the Transformer-based decoder based on the local observation and the information weight.

The policy network refers to a neural network in reinforcement learning that outputs a probability distribution of an action that the UAV should take or a specific action.

The coordinated decision-making refers to an action selection made jointly by each UAV in a multi-UAV swarm through mutual cooperation, information sharing, and policy adjustment, which is beneficial for achieving a group goal.

In some embodiments, the processor generates an execution action of the UAV through the policy network by performing coordinated decision-making based on the local action-value function.

In some embodiments, the policy network receives the local action-value function output from the mixing network or the Transformer-based decoder. The policy network takes the local action-value function as an input and outputs a probability distribution of each possible action. The policy network selects an action according to the probability distribution as a final execution action.

Some embodiments of the present disclosure provide a method for coordinated control of a UAV swarm based on communication information completion. By dynamically evaluating an importance of information through the information-level weighting network and combining with the adaptive generation network to generate an accurate global state, the method solves a coordination problem caused by incomplete information in the multi-UAV system. The mixing network integrates joint training of the local action-value function and the generative adversarial network, improving a quality of the global state and a capability of the coordinated decision-making. In the distributed execution phase, the Transformer-based decoder enables the UAVs to make decisions independently and cooperatively. The method can improve a task success rate and reduce a demand for communication bandwidth, thereby significantly enhancing adaptability and robustness of the UAV swarm in complex dynamic environments.

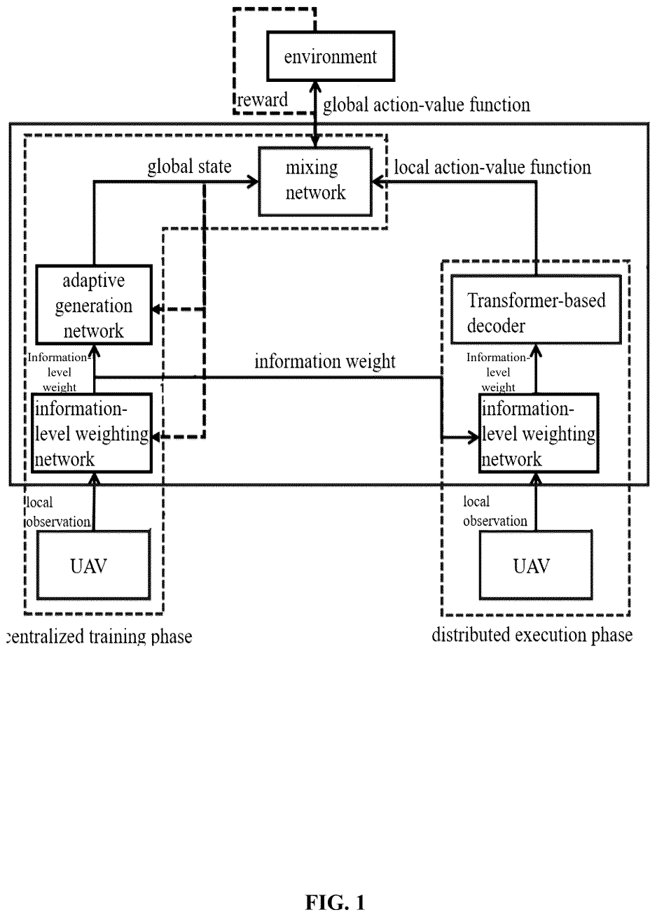

The present disclosure designs a plug-and-play multi-UAV reinforcement learning module unit that simultaneously includes functions such as communication, information completion, decision-making, and adaptive weighting for communication information completion. In some embodiments of the present disclosure, the plug-and-play multi-UAV reinforcement learning module unit is referred to as a “plug-and-play module” for short. The plug-and-play module includes four parts. FIG. 1 is a schematic diagram illustrating the plug-and-play module according to some embodiments of the present disclosure. As shown in FIG. 1, the plug-and-play module includes: the information-level weighting network for generating the information weight, the adaptive generation network for generating the global state, the Transformer-based decoder for integrating information and extracting features, and the mixing network for generating the global action-value function.

In some embodiments, the local observation is provided by each UAV. At each time step t, each UAV receives a local observation from an observation function.

In some embodiments, the information-level weighting network has an attention mechanism, which takes the local observation of each UAV as a query vector and local observations of all UAVs as keys and values.

In some embodiments, a process of obtaining the information weight is implemented through the information-level weighting network. The process includes: performing positional encoding on the local observation, and then calculating an information-level weight through a dot product attention mechanism.

In some embodiments, a process of generating the global state is implemented through the adaptive generation network. The process includes: inputting the weighted information into the information completion network, using the U-Net for information completion modeling, and outputting a generated global state. The process further includes: inputting the generated global state into a global discriminator network, fusing the generated global state through a cascade of layers with a sigmoid activation function, and outputting a probability of the global state being authentic to evaluate the performance of the information completion network.

In some embodiments, the processor performs a coordinated decision-making process. The coordinated decision-making process includes updating a policy through an action-value function.

In some embodiments, the processor generates adjusted flight parameters based on action execution of the UAV swarm and a feedback signal of each sensor; generates a control signal through the policy network based on the adjusted flight parameters; instructs the UAV swarm to move based on the adjusted flight parameters through the control signal; when an obstacle is detected, instructs the UAV swarm through the control signal to generate an updated flight trajectory and an updated flight speed based on a relative position and distance information of the obstacle fed back by the sensor; and controls the UAV swarm to move to avoid the obstacle based on the updated flight trajectory and the updated flight speed.

The feedback signal of the sensor refers to environment and self-state information acquired by the sensor configured on the UAV. More description regarding the sensor may be found in the related descriptions above.

The flight parameter refers to an indicator describing a flight state and motion characteristics of the UAV. For example, the flight parameter includes a speed, a heading, an altitude, an attitude angle, an acceleration, an angular velocity, etc.

In some embodiments, when detecting that a deviation between an actual speed, heading, or altitude of the UAV and an expected value exceeds a set threshold, or a change in an external environment (e.g., a wind speed, an air pressure, a temperature, etc.) exceeds a change threshold, thereby resulting in an unstable flight attitude, the processor automatically enters a parameter adjustment phase. The processor fuses an execution result with the feedback signal of the sensor to obtain a complete flight state vector.

In some embodiments, the policy network takes the flight state vector and a current global state as input, calculates a difference between an expected state and an actual state, and generates a corresponding adjustment amount based on the difference. The adjustment amount includes a speed adjustment amount, a heading adjustment amount, and an altitude adjustment amount, thereby forming adjusted flight parameters for the entire UAV swarm.

The execution result refers to an actual flight state of the UAV after completing a flight action according to the control signal. For example, the execution result includes a real-time speed, attitude angle, heading, acceleration, position, or the like.

The control signal refers to an instruction sent by the policy network or a control system to the UAV to instruct the UAV to perform a specific action or adjust a flight state. For example, the control signal includes an electrical signal for adjusting an engine speed of the UAV, a deflection angle of a control surface, a flight direction, or a flight altitude.

In some embodiments, the policy network generates an overall speed, heading, and altitude adjustment direction at the UAV swarm level. Combining with a relative position and a current flight state (including a real-time speed, attitude angle, heading, acceleration, and position) of each UAV in a formation, the overall adjustment direction is decomposed into local adjustment parameters corresponding to all UAVs. After receiving the local adjustment parameter, each UAV corrects the flight speed, heading angle, and flight altitude in real time, so that all UAVs synchronously move along a same path direction while maintaining relative spacing and attitude stability.

In some embodiments, during execution of a cooperative movement by the UAV swarm, an onboard sensor of each UAV continuously detects obstacle information in a surrounding space. Each UAV feeds back the relative position and distance information of the obstacle to the system. When detecting that a distance between any UAV and the obstacle is lower than a preset safety threshold, an obstacle avoidance control process is immediately triggered. The policy network generates correction parameters based on a direction and a distance of the obstacle. The correction parameters are used to adjust a speed, a heading, or an altitude of an affected UAV. If the obstacle is located in front of a path and can be bypassed through lateral offset, the processor corrects the heading to change the flight trajectory. If the obstacle is too close or cannot be quickly bypassed, the processor reduces the flight speed of the UAV or temporarily hovers to avoid a collision risk. Other UAVs adaptively adjust the flight parameters according to a new global state, thereby completing an obstacle avoidance operation while maintaining cluster stability, and ultimately achieving unified control of local obstacle avoidance and global cooperation.

In some embodiments of the present disclosure, the adjusted flight parameters are generated based on the action execution of the UAV swarm and the feedback signal of the sensor to optimize a group flight attitude of the UAV swarm in real time. Meanwhile, when the obstacle is detected, the system generates the updated flight trajectory and the updated flight speed based on the obstacle information fed back by the sensor, effectively guiding the UAV swarm to avoid the obstacle, improving flexibility and safety of coordinated control of the UAV swarm, and enabling the UAV swarm to better adapt to a complex dynamic environment.

In some embodiments, the plug-and-play module supports seamless integration into a multi-UAV reinforcement learning network, providing support for coordinated control of the multi-UAV system and enhancing communication and decision-making of the UAVs.

As shown in FIG. 1, the plug-and-play module includes the information-level weighting network, the adaptive generation network, the Transformer-based decoder, the mixing network, the UAVs, and an environment.

The information-level weighting network is configured to receive the local observation of the UAV through a communication part of the network, generate the information-level weight in the centralized training phase, and input the information-level weight into the adaptive generation network. The information-level weighting network is further configured to obtain a weight in a generation model through the communication part of the network. In the distributed execution phase, the information-level weighting network implements weighted extraction of information, filters redundant information, and inputs the weighted extracted information into the policy network of the UAV.

In some embodiments, communication information input to the information-level weighting network is the local observation of each UAV. After feature extraction, the local observation may be represented as a one-dimensional vector of a length l, denoted as

$${m}_{t}^{i} = {o}_{t}^{i} ∈ {R}^{l} ,$$

where

$${o}_{t}^{i}$$

represents an observation. In a full communication scenario, complete information acquired by each UAV at a time t is defined as

$${M}_{t}^{i , - i} = \{ {o}_{t}^{i} , {m}_{t}^{- i} \} ∈ {R}^{n \times l} ,$$

where—i represents all other UAVs except a UAV i. The weighted information includes a time, a target, and content of the communication and a weight. A calculation formula of the weighted information is shown in Formula (1). In some embodiments, the weighted information of each UAV is obtained based on the information weight through the following formula:

$${x}_{t}^{i} = ( 1 - {W}_{t}^{i} ) \cdot {M}_{t}^{i , - i} + {W}_{t}^{i} \cdot {ϵ}_{t} , {ϵ}_{t} ∼ 𝒩 ( 0 , I ) , \qquad ( 1 )$$

where

$${x}_{t}^{i}$$

represents weighted information of the UAV i at the time t,

$${W}_{t}^{i}$$

represents an information weight of the UAV i at the time t,

$${M}_{t}^{i , - i} = \{ {o}_{t}^{i} , {m}_{t}^{- i} \} ∈ {R}^{n \times l}$$

represents complete information obtained by the UAV i at the time t,

$${m}_{t}^{- i}$$

represents a set of local observations of the other UAVs excluding the UAV i at the time t, Et represents white noise, [symbol] (0, I) represents a normal distribution, and I represents an identity matrix. The information-level weighting network is jointly trained with the adaptive generation network during the centralized training phase, with their parameters updated collectively.

The complete information refers to all data obtained by the UAV i at the time t, including the local observation of the UAV i and information obtained by other UAVs.

In some embodiments, the complete information obtained by the UAV i at the time t includes the local observation of the UAV i and a set of local observations of other UAVs (excluding the UAV i) at the time t.

More description regarding the information weight and the weighted information may be found in the related descriptions above.

In some embodiments of the present disclosure, by introducing the information weight, the UAV can adaptively balance influence of the complete information from itself and other UAVs with external uncertainty (white noise). The mechanism significantly enhances robustness of the UAV swarm when facing sensor noise, communication interruption, or environment interference. Through a flexible adjustment, the mechanism can effectively optimize information fusion, improve state estimation accuracy and coordinated control efficiency of the UAV in a dynamic and unpredictable environment, thereby enhancing a success rate and safety of task execution.

The adaptive generation network is configured to receive the local observation of the UAV through the communication part of the network, generate the information-level weight with assistance of the information-level weighting network and perform joint training, complete the communication information, and output the generated global state. The global state is used as an input of the mixing network, which helps enhance the expression capability of the global action-value function. The adaptive generation network includes n input channels and one output channel, and integrates the local observations of the UAVs into a communication process to ensure scalability. The adaptive generation network uses an MSE loss and a GAN loss to update the parameter in the centralized training phase. More content regarding the adaptive generation network may be found in the related descriptions below.

The mixing network is configured to aggregate the local action-value function of each UAV to form the global action-value function, so as to guide an overall policy iteration of the multi-UAV system. The input of the mixing network includes the local action-value function of each UAV and the global state output by the adaptive generation network. An output of the mixing network includes the global action-value function, which evaluates an overall value of the multi-UAV system performing a certain cooperative action in a certain state. The UAV swarm interacts with the environment to obtain the reward based on the global action-value function, and updates the parameter of the mixing network based on the reward.

In some embodiments, the adaptive generation network includes the information completion network and the global discriminator network. The information completion network is connected to the information-level weighting network. The information completion network adopts a U-Net architecture and follows an encoder-decoder architecture.

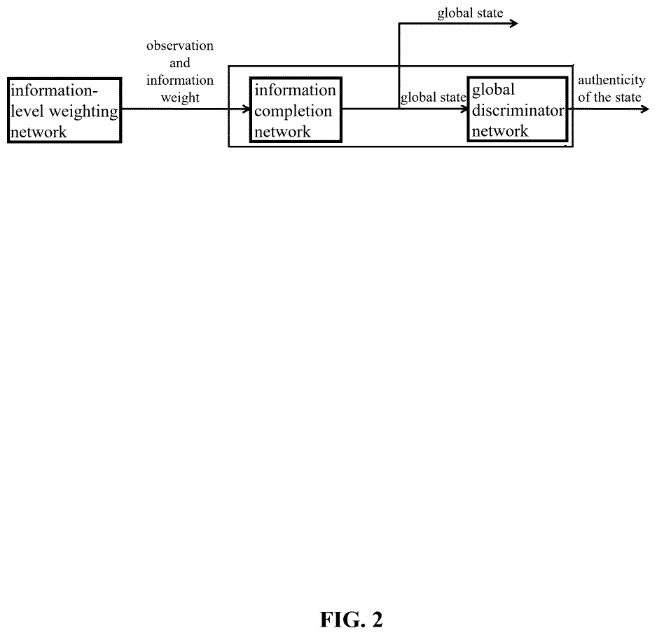

FIG. 2 is a schematic diagram illustrating an adaptive generation network according to some embodiments of the present disclosure. As shown in FIG. 2, the adaptive generation network includes an information completion network and a global discriminator network. The information completion network is connected to an information-level weighting network.

The information completion network receives a local observation of a UAV and weighted information generated by the information-level weighting network through a communication part of the network, completes information, and generates a global state. The information completion network is composed of repeated one-dimensional convolutional residual blocks, adopts the U-Net for information completion modeling, and follows an encoder-decoder architecture. Downsampling is performed to reduce memory usage and computation time before further processing information, and then upsampling is performed to restore an output to a length of the global state.

The information completion network refers to a component in the adaptive generation network. The information completion network is configured to generate or restore a complete global state based on input local or incomplete information.

The global discriminator network refers to a component in the adaptive generation network. The global discriminator network is configured to evaluate authenticity or quality of the global state output by a generator (the information completion network).

In some embodiments, the adaptive generation network is configured as a Generative Adversarial Network (GAN) architecture.

For example, the information completion network serves as the generator, receives local or incomplete communication information of the UAV swarm as an input, and estimates missing information to generate the complete global state.

The global discriminator network serves as a discriminator, receives the global state generated by the information completion network or real complete global state data, and evaluates authenticity of the global state, thereby guiding the information completion network to generate more accurate and credible information.

In some embodiments, the information completion network is connected to the information-level weighting network.

The information-level weighting network may dynamically assign weights based on reliability, timeliness, or importance of communication information. For example, information from a UAV with a high signal strength or a short distance may be assigned a higher weight, and information from a UAV with poor communication quality may be assigned a lower weight, thereby guiding the information completion network to prioritize processing of high-quality data.

In some embodiments, the information completion network adopts the U-Net architecture. The U-Net architecture refers to a deep learning neural network architecture, usually used for an image segmentation task, characterized by an encoder (a downsampling path) and a decoder (an upsampling path), with a skip connection between the encoder and the decoder.

In some embodiments, the U-Net architecture is beneficial for processing an information completion task involving spatial or sequence data, and may capture both high-level contextual information and fine-grained details.

In some embodiments, the information completion network follows the encoder-decoder architecture. The encoder-decoder architecture refers to a neural network architecture, where the encoder is responsible for compressing or converting input data into a low-dimensional representation (a feature vector), and the decoder is responsible for restoring or converting the low-dimensional representation into required output data.

In some embodiments of the present disclosure, by constructing the adaptive generation network including the information completion network and the global discriminator network, and adopting the U-Net and the encoder-decoder architecture, a problem of incomplete communication information of the UAV swarm is effectively solved. The information completion network can restore a missing global state with high accuracy, and the global discriminator network ensures authenticity and quality of generated information. The skip connection of the U-Net retains fine spatial and contextual details, improving completeness and accuracy of state perception of the UAV swarm. A reliable decision-making basis is provided for coordinated control of the UAV swarm, reducing errors caused by information loss, thereby enhancing robustness and efficiency of overall task execution.

In some embodiments, the adaptive generation network further includes an environment feature extraction network. The environment feature extraction network is connected to the information completion network, and adopts a structure combining a convolutional neural network (CNN) and an attention mechanism. The environment feature extraction network is configured to extract environment features at multiple levels from the weighted information of each UAV and update the global state, the environment features including a texture feature, an illumination feature, and a semantic feature.

The environment feature extraction network refers to a network module configured to extract a feature representation reflecting an overall environment state from the weighted information uploaded by each UAV.

In some embodiments, the environment feature extraction network adopts a structure combining a convolutional layer and the attention mechanism. The convolutional layer is configured to capture local spatial features and edge details in input information. The attention mechanism is configured to highlight key regions and suppress redundant information in a feature map. The combination of the convolutional layer and the attention mechanism may enhance understanding capability of a global relationship of the environment while ensuring local perception accuracy, thereby improving effectiveness of overall feature expression.

In some embodiments, an input of the environment feature extraction network includes the weighted information, and an output of the environment feature extraction network includes the environment feature.

The environment feature refers to key information extracted from the environment to describe a state or an attribute of the environment. For example, the environment feature includes the texture feature, the illumination feature, the semantic feature, or a terrain feature.

The texture feature refers to a feature reflecting surface morphology and spatial detail information. The texture feature is used to distinguish different ground surfaces, obstacles, or regional structures.

The illumination feature refers to illumination condition information formed by an environment light intensity distribution, a reflectivity, and shadow variation. The illumination feature is used to describe a brightness mode and a light source direction of a scene.

The semantic feature refers to information related to meaning of a scene learned by a network in a high-level feature space. For example, the semantic feature includes a regional category, a functional attribute, etc.

In some embodiments, the environment feature extraction network takes the weighted information as a multi-channel input of the feature map, and gradually extracts a low-level texture feature and the illumination feature through the convolution layer. The attention mechanism dynamically focuses on a key region based on a weight of information and a spatial distribution of each UAV, thereby obtaining a fused high-level semantic feature. The extracted multi-layer environment features are integrated to form a global feature representation, which is used to update a global state of a system, enabling the global state to real-time reflect the UAV swarm's comprehensive cognition of the environment.

More descriptions regarding the weighted information and the attention mechanism may be found in the related descriptions below.

In some embodiments of the present disclosure, by introducing the environment feature extraction network integrating the CNN and the attention mechanism, local details and global semantic information of the environment can be captured simultaneously, accuracy and feature expression capability of environment modeling are significantly improved, enhancing comprehensive cognition and situation awareness capability of the UAV swarm in a complex environment, thereby improving robustness and decision-making efficiency of multi-UAV coordinated control.

If a similarity between a current environment feature and a historical environment feature is higher than a preset threshold, it indicates that a change of a current environment is small or the current environment is consistent with a historical environment. If the similarity between the current environment feature and the historical environment feature is lower than the preset threshold, it indicates that the current environment feature is significantly different from the historical environment feature, and the historical environment feature is insufficient to reliably describe the current environment.

In some embodiments, in response to the similarity between the current environment feature and the historical environment feature being lower than the preset threshold: the processor copies a current adaptive generation network to generate a model to be updated; and trains the model to be updated by a second UAV to obtain an updated adaptive generation network.

The historical environment feature refers to environment feature data recorded and stored by the processor at different time points or in different scenarios in the past.

In some embodiments, the processor analyzes the similarity between the current environment feature and the historical environment feature based on a distance metric or a correlation in a feature space. For example, the processor evaluates a proximity degree between the current environment and the historical environment in dimensions of the texture feature, the illumination feature, and the semantic feature by calculating an indicator such as a Euclidean distance, a cosine similarity, or a correlation coefficient between the feature vectors.

To ensure calculation consistency, the processor performs normalization on the feature vectors before performing similarity comparison.

In some embodiments, the preset threshold may be set manually based on historical experience.

The model to be updated refers to a model version copied from a historical model and requiring further training and optimization.

In some embodiments, the processor trains the model to be updated based on a training sample and a training label to obtain an updated adaptive generation network.

The training sample includes the current environment feature and the weighted information generated by the information completion network.

In some embodiments, the second UAV collects the training sample from an operation process of the UAV swarm. Each training sample includes the current environment feature and the weighted information generated by the information completion network.

In some embodiments, the training sample may also be obtained in various other ways. For example, the training sample is generated by simulating the environment.

In some embodiments, the training label includes a reference label output by a historical model. The historical model predicts the training sample in the current environment, and takes an output as the training label of the model to be updated, to maintain feature consistency of the model.

In some embodiments, the training label further includes a self-supervised label generated based on environment feedback. After the UAV performs an exploratory action in a new environment, an environment interaction module provides a reward signal. The reward signal is smoothed and used as a learning target reflecting a change in a current environment feature.

The reward signal refers to numerical feedback obtained by an agent (the UAV swarm) from the environment interaction module after interacting with the environment in reinforcement learning, which is used to indicate the quality of an action of the agent.

The training label is automatically generated by an internal mechanism of the system.

In some embodiments, the processor compares an output result of a new model with the reference label and the self-supervised label, respectively, and calculates corresponding loss values. A difference from the reference label is used to calculate a retention loss, which constrains a distance between the output of the new model and the output of an old model in the feature space. A difference from the self-supervised label is used to calculate a reconstruction loss, which measures consistency between the global state generated by the model and an environment feedback target.

In some embodiments, the processor performs a weighted sum of two loss functions, namely the retention loss and the reconstruction loss, to form a comprehensive loss function. Weights are automatically adjusted by the system during a training process. The reconstruction loss is used to maintain consistency between the global state output by the model and an actual observed state, ensuring that the model can still accurately reflect structural information of the current environment. The retention loss is used to constrain a difference between an output of the model to be updated and an output of the historical model, preventing forgetting of existing important feature representations when learning a new environment feature.

In some embodiments, when a trained model satisfies a preset training condition, the training ends. The preset training condition may include one or more of the following: a decrease amplitude of the comprehensive loss in consecutive multiple rounds of iterations being lower than a preset threshold, a prediction error of the model on a verification sample being stable within a target range, or reaching a set count of training rounds or time limit.

In some embodiments, the updated model (the updated adaptive generation network) may also be deployed to other UAVs or a central controller to achieve distributed sharing and application of the model.

In some embodiments of the present disclosure, by identifying an environment change and automatically initiating a model update, adaptive capability and control accuracy of the UAV swarm in a complex dynamic environment are significantly improved. The method avoids a lag of manual intervention, ensures that the system can quickly respond to new environment challenges, effectively reduces a task failure rate, and improves resource utilization efficiency.

In some embodiments, the processor establishes an environment knowledge base. The environment knowledge base is configured to store a mapping relationship between historical environment features and parameters of the adaptive generation network; and in response to the similarity between the current environment feature and the historical environment feature being higher than the preset threshold, retrieve a parameter of the adaptive generation network that satisfies a preset condition with the current environment feature from the environment knowledge base.

The environment knowledge base refers to a collection used for storing and managing knowledge, data, and model parameters related to the environment, to support adaptability and decision-making of the system in different environments. The processor may establish the environment knowledge base based on historical data.

The parameters of the adaptive generation network refer to a set of numerical values that may be adjusted and optimized in the adaptive generation network. The parameters of the adaptive generation network determine a specific behavior and performance of the network in generating the global state.

The mapping relationship refers to a corresponding relationship between two sets (e.g., environment features and model parameters). Each element in one set is associated with a unique element or a plurality of elements in another set.

In some embodiments, the mapping relationship between the historical environment feature and the parameter(s) of the adaptive generation network may be generated in a plurality of ways. For example, the processor may use a machine learning model, such as a neural network or a support vector machine, to train a large amount of historical data, learn an optimal network parameter configuration under different environment features, thereby establishing an association between the environment feature and the parameter(s).

In some embodiments, the similarity between the current environment feature and the historical environment feature may be determined by calculating a Euclidean distance or a cosine similarity between feature vectors of the current environment feature and the historical environment feature. In some embodiments, the processor may also perform calculation through a pattern matching algorithm to identify a key pattern matching degree between the current environment feature and the historical environment feature.

In some embodiments, in response to the similarity between the current environment feature and the historical environment feature being higher than the preset threshold, the processor retrieves the parameter(s) of the adaptive generation network that satisfies the preset condition with the current environment feature from the environment knowledge base.

Satisfying the preset condition refers to that an invoked parameter(s) enables a control performance of the UAV swarm in the current environment to reach a specific standard. For example, the preset condition may be to select a parameter set with a highest similarity and an optimal operation effect of the UAV swarm previously. As another example, the preset condition may also be that the invoked parameter(s) satisfies a specific real-time requirement, a computing resource constraint, or an energy consumption target. In some embodiments, the preset condition may also be defined according to a specific application scenario and a system requirement. For example, the preset condition includes effectiveness, availability, or qualification through a verification test of the parameter(s).

In some embodiments of the present disclosure, by establishing the environment knowledge base to store the mapping relationship between the historical environment features and the parameters of the adaptive generation network, experience accumulation of the environment and the model parameter is achieved. When an environment similar to a historical environment is detected, the system responsively invokes the parameter(s) of the adaptive generation network that satisfies the preset condition from the knowledge base, which significantly improves an adaptation speed of the UAV swarm in a dynamic environment, effectively saves computing resources and time, enables the system for coordinated control of the UAV swarm to quickly respond to the environment change, and improves overall operation efficiency and reliability.

In some embodiments, the processor determines a statistical correlation between a plurality of historical environment features and corresponding parameters of the adaptive generation network based on the environment knowledge base; and guides a parameter initialization of the model to be updated based on the statistical correlation.

The statistical correlation refers to a variation relationship between the plurality of historical environment features and the corresponding parameters of the adaptive generation network in the environment knowledge base. The statistical correlation is used to reflect an influence degree of a change in a specific environment feature on a model performance and a parameter configuration.

In some embodiments, the processor obtains stored historical environment records from the environment knowledge base, and extracts a numerical relationship between each group of environment features (e.g., a texture complexity and an illumination intensity distribution) and the corresponding parameters of the adaptive generation network (e.g., a weight distribution of a convolutional layer and an attention coefficient). The processor uses a multi-dimensional feature mapping manner to establish a feature-parameter correspondence matrix, and performs correlation analysis on a feature similarity and a model performance change. Through statistical calculation (e.g., a correlation degree evaluation based on covariance or mutual information), the processor identifies parameters that are most sensitive to the change in the environment feature, and generates parameter adjustment weights for subsequent parameter initialization and adaptive adjustment.

In some embodiments, based on the statistical correlation, the processor uses the parameter adjustment weights to perform weighted fusion on parameter distributions of similar environments in the knowledge base (e.g., historical environment features with a top-5 similarity ranking and corresponding parameters), to obtain an expected parameter distribution (including a mean and a variance) for the current environment, and uses the expected parameter distribution as an initial parameter value of each layer of the model to be updated.

The processor uses the mean as a center of the parameter initialization, and uses the variance as a range of the random initialization.

For example, for a certain parameter, in five historical models with the environment features similar to the current environment feature, a mean is 0.8, and a variance is 0.05. In the current environment, the parameter may be approximately near 0.8, but a random fluctuation is allowed within a range of ±0.05.

In some embodiments of the present disclosure, by determining the statistical correlation between the historical environment features and the parameters of the adaptive generation network based on the environment knowledge base, and guiding the parameter initialization of the model to be updated based on the statistical correlation, historical model knowledge can be effectively utilized, thereby significantly accelerating a convergence process of a new model, avoiding training instability caused by random initialization, and improving a learning efficiency and an adaptability of the model in a new environment.

A function of the global discriminator network is to identify whether the global state is authentic or generated through the local observation. The global discriminator network compresses the global state into a compact feature vector based on a one-dimensional convolutional neural network. An output of the network is fused through a connection layer. The connection layer uses a sigmoid activation function to predict a continuous value between 0 and 1, which represents a probability that the global state corresponds to a real situation rather than being caused by information completion.

In some embodiments, a process of obtaining an information weight through the information-level weighting network includes obtaining input information, i.e., the local observation of the UAV, through a communication part of the plug-and-play module.

In some embodiments, the processor performs positional encoding on a local observation

$${o}_{t}^{i}$$

of a UAV i and information

$${m}_{t}^{- i}$$

obtained from other UAVs, converts the local observation

$${o}_{t}^{i}$$

of the UAV i and the information

$${m}_{t}^{- i}$$

into vector representations containing positional information to obtain position-encoded vectors. The processor performs repetition processing on the position-encoded vectors, converts the position-encoded vectors into an input format (including query and key-value) for the attention mechanism, where after repetition processing a position-encoded vector of the local observation

$${o}_{t}^{i}$$

of the UAV i by a multi-layer perception (MLP), a query vector

$${Q}_{t}^{i}$$

is generated, and after processing the information

$${m}_{t}^{- i}$$

obtained from the other UAVs, a key vector

$${K}_{t}^{i}$$

and a value vector

$${V}_{t}^{i}$$

are generated. The processor calculates a dot product of the query vector

$${Q}_{t}^{i}$$

and the key vector

$${K}_{t}^{i}$$

to obtain an attention score, applies a softmax function to the attention score to perform normalization processing, thereby obtaining information weights between UAVs.

In some embodiments, a query of the attention mechanism is the local observation

$${o}_{t}^{i} ,$$

and a calculation formula is shown as Formula (2):

$${Q}_{t}^{i} = M L {P}_{Q , K , V} ( {\underbrace{[ {o}_{t}^{i} , … … , {o}_{t}^{i} ]}}_{m} ) , \qquad ( 2 )$$

where

$${Q}_{t}^{i}$$

represents an i-th query at a time t, MLP represents the multi-layer perceptron, and m represents a count of repetition processing times.

In some embodiments, the local observations of all UAVs are used as a key and a value, and a calculation formula is shown as Formula (3):

$${K}_{t}^{i} , {V}_{t}^{i} = M L {P}_{Q , K , V} ( [ {M}_{t} ] ) , \qquad ( 3 )$$

where Mₜ represents a set of local observations of all UAVs at the time t.

In some embodiments, a calculation formula of the information weight is shown as Formula (4):

$${W}_{t}^{i} = σ ( {MLP}_{Q , K , V} ( softmax ( \frac{{Q}_{t}^{i} {K}_{t}^{{i}^{T}}}{\sqrt{d}} ) {V}_{t}^{i} ) ) , \qquad ( 4 )$$

where d represents a dimension of the query vector and the key vector, σ represents a ReLU activation function, softmax is a normalization algorithm, and

$${W}_{t}^{i}$$

represents an information weight of the UAV i at the time t.

The set of local observations refers to a complete set of local observation obtained by each UAV in the UAV swarm at the time t.

In some embodiments, the processor calculates the dot product of the query vector and the key vector to obtain the attention score, applies the softmax function to the attention score to perform normalization, and obtains the information weights between the UAVs.

The dot product refers to a sum of products of corresponding components of two vectors. The dot product is used to measure a similarity or a correlation between the two vectors.

The attention score refers to a value obtained after the dot product of the query vector and the key vector in the attention mechanism, which quantifies a degree of correlation between each element in an input sequence and the query.

More descriptions regarding the information weight may be found in the related descriptions above.

The dimension refers to a value describing a count of components contained in a vector or a tensor in mathematics or computer science.

Elements involved in the above Formula (3) and Formula (4) may be obtained by invoking system stored data or historical calculation data.

In some embodiments of the present disclosure, by introducing the information-level weighting network, a local observation of an individual UAV and information of other UAVs are deeply fused and dynamically weighted. The query vector, the key vector, and the value vector are generated through positional encoding, repetition processing, and the MLP. A scaled dot-product attention mechanism and the softmax function are used to calculate the information weight, so that the UAV can accurately identify and focus on external information most critical to its own decision-making, which effectively solves a problem that a traditional fixed weight or a simple fusion mechanism is difficult to adapt to a complex dynamic environment, and significantly improves a coordination efficiency and a task adaptability of the UAV swarm.

In some embodiments, the processor monitors a computing resource state of each UAV, and obtains the information weight through the information-level weighting network based on the computing resource state and the local observation.

The computing resource state refers to a real-time usage of hardware and software resources currently used by the UAV to execute a computing task. For example, the computing resource state includes a utilization rate of a processor (e.g., CPU), a memory occupancy, a cache hit rate, a battery level, and a discharge rate.

In some embodiments, each UAV is further configured with a resource monitoring module for continuously collecting and updating a current computing resource state.

In some embodiments, the processor obtains the information weight through the information-level weighting network based on the computing resource state and the local observation.

In some embodiments, the weighting network establishes a mapping relationship between the computing resource state and the local observation, and evaluates a contribution degree of each UAV to a group decision-making at a current time through feature weighting. The contribution degree indicates whether information is reliable. The contribution degree is positively correlated with the weight.

The computing resource state reflects a processing capability and a stability of a node. The local observation reflects a quality of environment information of the node.

In some embodiments, the processor adjusts a weight distribution corresponding to each UAV based on the contribution degree. For example, the processor increases the information weight corresponding to a UAV with a high contribution degree, so that a UAV with sufficient computing resources and a high observation quality obtains a higher weight in an information fusion process.

In some embodiments, the information weight may also be obtained through a mapping table. The mapping table is obtained by invoking system stored data.

In some embodiments of the present disclosure, by incorporating the computing resource state of the UAV into consideration of the information-level weighting network, reliability and priority of information from different UAVs can be dynamically adjusted. It avoids decision-making errors or delays caused by relying on information provided by the UAV with a limited computing capability, thereby improving overall coordinated control efficiency and decision-making accuracy of the UAV swarm. Particularly in complex task scenarios with dynamically changing resources, task success rate and system robustness can be effectively enhanced.

In response to detecting that a first UAV has a computational load greater than an upper threshold, a load imbalance situation currently exists, and a load mitigation process is needed to be initiated.

In some embodiments, in response to detecting that the first UAV has the computational load greater than the upper threshold: the processor identifies a second UAV having a computational load less than a lower threshold; determines a task migration policy based on a task type and a communication state; migrates a target task of the first UAV to the second UAV for execution based on the task migration policy; and returns a task result to the first UAV after the second UAV completes the target task.

In some embodiments, the computational load refers to a proportion of processor resources occupied by the UAV when processing a task at a certain moment. The computational load is used to reflect a real-time computing pressure of a node.

In some embodiments, the processor obtains the computational load by performing a weighted summation based on the computing resource state.

In some embodiments, the upper threshold refers to a maximum acceptable value set for a certain indicator (e.g., the computational load), and once the indicator exceeds the value, a specific response or alarm is triggered.

In some embodiments, the first UAV refers to a UAV that needs to migrate out a portion of tasks due to an excessively high computational load in a task migration or resource scheduling scenario.

In some embodiments, the processor detects that the first UAV has the computational load greater than the upper threshold. When an evaluation value of a computational load of a UAV is higher than the upper threshold, the UAV is identified as the first UAV.

In some embodiments, the lower threshold refers to a minimum acceptable value set for a certain indicator (e.g., the computational load), and once the indicator is lower than the value, a specific response or alarm is triggered.

In some embodiments, the upper threshold and the lower threshold may be set based on historical experience.

In some embodiments, the second UAV refers to a UAV that is selected to receive a task due to a relatively idle computational load in the task migration or resource scheduling scenario.

In some embodiments, the processor identifies the second UAV with the computational load less than the lower threshold. For example, the first UAV or a cluster management system broadcasts a query request to neighboring UAVs. The neighboring UAVs that receive the request send own real-time computational load values to the first UAV or the cluster management system. The first UAV or the cluster management system filters out a UAV with the computational load value lower than the lower threshold and designates the UAV as a potential second UAV.

In some embodiments, the task type refers to a specific category or nature of a task performed by the UAV swarm. For example, the task type includes path planning, image recognition, target tracking, communication relay, obstacle avoidance calculation, area reconnaissance, or material delivery.

In some embodiments, the task type and a corresponding UAV type may also be determined by looking up a preset table. The preset table is determined based on the task types and corresponding UAV types in historical working data of the UAVs.

The communication state refers to real-time performance and reliability indicators of a communication link between the UAVs. For example, the communication state includes signal strength, data transmission rate, network delay, packet loss rate, or communication bandwidth.

In some embodiments, the processor obtains the communication state via a communication module installed on the UAV.

The task migration policy refers to a scheduling scheme formulated in the multi-UAV system to optimize computing resource allocation and load balancing, and to optimize overall computing resource utilization of the swarm.

In some embodiments, when detecting that the first UAV has the computational load greater than the upper threshold, the processor determines real-time performance and computational complexity of the task based on the task type. If the task belongs to a high-timeliness type, the processor preferentially selects a second UAV with lower communication delay for migration. If the task belongs to a computationally intensive type (e.g., image recognition or path optimization), the processor preferentially selects a second UAV with low computational load and a stable communication state.

In some embodiments, after comprehensively evaluating task execution requirements and communication conditions, the processor dynamically generates the migration policy, specifying a task allocation ratio, a data transmission direction, and a priority of the second UAV. The priority of the second UAV is determined based on the computational load of the second UAV. For example, the lower the computational load, the higher the priority.

The target task refers to a task that needs to be migrated from the first UAV to the second UAV.

The task migration refers to a process of transferring a task being executed or planned to be executed on one UAV to another UAV for continued execution.

In some embodiments, the first UAV may retain a portion of the target task to continue execution according to the policy, to reduce its own computational load below the upper threshold. In some embodiments, the target task may also be migrated to a plurality of second UAVs.

The task result refers to output data, a status update, or feedback information generated by the UAV after completing an assigned task. For example, the task result includes an output of image recognition or final path points of path planning.

In some embodiments, after the second UAV completes the target task migrated from the first UAV, the second UAV sends a generated task result back to the first UAV. The first UAV receives and processes the returned task result and integrates the task result into its own original task flow.

In some embodiments of the present disclosure, the processor can dynamically detect the computational load of the UAV, identify an idle UAV when overloaded, determine an optimal task migration policy, realize dynamic allocation of computing tasks and load balancing in the UAV swarm, effectively avoid response delays caused by overload of a single UAV, improve task execution efficiency and system robustness of the entire UAV swarm, and ensure timely completion of critical tasks.

In some embodiments, the processor performs downsampling processing on the weighted information

$${x}_{t}^{i}$$

of each UAV, inputs downsampled data into an encoder and a decoder of the information completion network, and outputs the global state.

A process of generating the global state by the adaptive generation network includes: obtaining input information from the communication part of the plug-and-play module, including the local observation and the information weight of the UAV; performing downsampling for preprocessing before further processing the information, to reduce memory usage and improve computational efficiency; restoring the information after downsampling to a length of the global state through upsampling; inputting the data after downsampling into the encoder and the decoder of the information completion network; inputting the weighted information into the information completion network to realize an information completion function, and sending the generated global state to a global discriminator network. A calculation formula for the weighted information is shown in Formula (1), and the output global state is mathematically defined as shown in Formula (5):

$${s}_{t} = G ( {x}_{t}^{1} , {x}_{t}^{2} , … , {x}_{t}^{n} ) , \qquad ( 5 )$$

where sₜ represents a global state at the time t generated by the information completion network, and n represents a count of UAVs in the UAV swarm.

In some embodiments, a process of determining whether the global state is authentic includes: inputting information (including the generated global state) from a communication part of the adaptive generation network; extracting local features from the input information through a one-dimensional convolutional neural network, then performing pooling to compress the global state into a compact feature vector; and outputting through a cascade of layers using a sigmoid activation function for fusion, outputting a probability that the global state corresponds to a real situation rather than being generated by information completion, thereby evaluating the performance of the adaptive generation network and improving the performance of the adaptive generation network through generative adversarial training.

In some embodiments of the present disclosure, by performing downsampling processing on dispersed weighted information of the UAVs, data dimensionality and computational load are effectively reduced. The encoder and the decoder of the information completion network are utilized to intelligently integrate data from each UAV and effectively complete missing information, which enables the UAV swarm to obtain a more comprehensive, accurate, and robust global state, significantly improves coordinated control capability and decision-making efficiency of the UAV swarm, and enhances adaptability and reliability of the system in complex environments.

In some embodiments, a process of obtaining an approximate global action-value function includes: inputting information (including the local action-value function of each UAV and the generated global state) from the communication part of the plug-and-play module; in a centralized training phase, determining weights of local action-value functions of all UAVs using the global state by learning a mixing network Qₜₒₜ(τ, α, m, s; θ) and utilizing an additive structure of a QMIX network, and synthesizing the local action-value function of each UAV into the global action-value function through the weights of the local action-value functions.

In some embodiments, the weight of the local action-value function may be determined by a plurality of machine learning models or algorithms, e.g., a neural network, a decision tree, a support vector machine, etc.

In some embodiments, the synthesis process is implemented by multiplying the local action-value function of each UAV by a corresponding weight and summing weighted local action-value functions.

In some embodiments, synthesizing the global action-value function may be implemented in a plurality of ways, e.g., linear weighted summation, nonlinear transformation, or through combination functions (e.g., product, maximum value).

In some embodiments of the present disclosure, by integrating local action-value functions through the mixing network and utilizing the additive structure of QMIX to dynamically determine weights of the local action-value functions based on the global state, the global action-value function is efficiently synthesized, which can effectively solve complex cooperation problems of multiple UAVs, improve task coverage, and enhance response speed to environment changes. Particularly under communication constraints, weight adjustment guided by the global state ensures coordination and decision quality of the UAV swarm, significantly improving cooperative efficiency and task success rate.

A parameter θ is updated by minimizing an expected temporal difference (TD) error:

$$ℒ ( θ ) = {\sum }_{i = 1}^{n} [ {( {y}_{i}^{t o t} - {Q}_{tot} ( {τ}_{t} , {α}_{t} , {m}_{t} , {s}_{t} ; θ ) )}^{2} ] , \qquad ( 6 )$$

where [symbol] (θ) represents the first loss function, n represents the count of UAVS,

$${y}_{i}^{t o t}$$

represents a target Q-value, Qₜₒₜ(τₜ, αₜ, mₜ, sₜ; θ) represents a mixing network Q-value at the time t, τₜ represents a historical observation at the time t, αₜ represents an action at the time t, mₜ represents information of the UAV swarm at the time t, sₜ represents the global state at the time t, θ represents the parameter of the mixing network.

A calculation process of

$${y}_{i}^{t o t}$$

is shown in Formula (7):

$${y}_{i}^{t o t} = r + {γmax}_{{a}_{t + 1}} {Q}_{tot} ( {τ}_{t + 1} , {α}_{t + 1} , {m}_{t + 1} , {s}_{t + 1} ; {θ}^{-} ) , \qquad ( 7 )$$

where θ⁻ represents a parameter of a target mixing network, r represents the reward obtained by the UAV swarm interacting with the environment, γ represents a discount factor, maxₐ_{ₜ₊₁} represents a Qₜₒₜ value of a maximized action αₜ₊₁.

The target mixing network is configured to calculate the target Q-value as an update target for a training network. More description regarding the mixing network may be found in the related descriptions above.

In some embodiments, a process of obtaining an approximate local action-value function includes: inputting information (including the local observation of the UAV) from the communication part of the plug-and-play module; and the a distributed execution phase, the UAV learning the Q-network Qⁱ(τ, α, m, s) to estimate the action-value function Qⁱ(s, a).

In some embodiments, the discount factor is a value between 0 and 1, which is used to balance an importance of a current reward and a future reward. For example, when the discount factor is close to 1, the future reward has a greater influence.

In some embodiments, the historical observation includes observation data of the UAV i over a past period of time. For example, the historical observation may include state information of the UAV i at past K time steps, such as a position, a speed, an orientation, and a perceived distance to the obstacle.

In some embodiments, the action refers to a set of actions taken by the UAV swarm at the time t. The action may be generated by the policy network or through an exploration mechanism.

In some embodiments, the UAV swarm information refers to information shared or aggregated among internal members of the UAV swarm at the time t.

In some embodiments, the UAV swarm information may be obtained through direct communication or through an intermediate coordinator for information aggregation and distribution.

More description regarding the global state may be found in the related descriptions above.

In some embodiments, the global state may be obtained through a global sensor (e.g., a ground radar) or through estimation after information aggregation within the UAV swarm.

In some embodiments, the reward refers to immediate feedback obtained by the UAV swarm after interacting with the environment. For example, when the UAV swarm successfully completes a task, a positive reward is obtained. When the UAV swarm fails to complete the task, a negative reward is obtained.

In some embodiments of the present disclosure, by introducing the first loss function based on a squared error between the target Q-value and the mixing network Q-value, and using the target network to calculate a future Q-value, a cooperative policy of the UAV swarm can be learned stably. The loss function combines the historical observation, the action, the UAV swarm information, and the global state, enabling the mixing network to comprehensively understand multi-agent interactions, thereby significantly improving adaptability and cooperative efficiency of the UAV swarm in a dynamic environment.

In some embodiments of the present disclosure, a process of simultaneously training the adaptive generation network and the information-level weighting network and updating the parameters uses two loss functions: an MSE loss for stability and a GAN loss for enhancing authenticity of a result. By combining the two loss functions, the generation network and the discriminator network undergo adversarial training, and an optimization manner is transformed as follows:

$${min}_{D} {max}_{G} \{ - {E}_{o ∼ O} {ℒ}_{M S E} - {E}_{s ∼ S} log D ( {s}_{t} ) - α {E}_{o ∼ O} log ( 1 - D ( {s}_{t} ) ) \} ,$$

$${ℒ}_{M S E} = {‖ O ( {s}_{t} ) - {o}_{t} ‖}^{2} ,$$

where [symbol] _{MSE} represents a second loss function, ∥·∥ represents a Euclidean norm, oₜ represents an actual local observation, O(sₜ) represents a local observation predicted according to the global state, D represents a global discriminator network in the adaptive generation network, G represents an information completion network in the adaptive generation network, E represents calculating an expectation, o~O represents sampling o from a distribution O, s~S represents sampling s from a distribution S, sₜ represents the global state at the time t, D(sₜ) represents a probability of determining whether the global state sₜ is authentic, which is output by inputting the global state sₜ into the global discriminator network, oₜ represents the local observation at the time t, and a represents a weight hyperparameter.

According to the method for coordinated control of the UAV swarm in some embodiments of the present disclosure, by adopting the generative adversarial network loss function, local observation and global state information can be effectively fused. The loss function, by balancing a reconstruction error and adversarial learning, enables the information completion network to generate a high-quality, realistic, and globally state-consistent local observation, significantly improving accuracy and completeness of global situational awareness, thereby ensuring robustness of coordinated decision-making and coordinated control of the UAV swarm, and effectively improving a task success rate in a complex task environment.

In some embodiments, the processor obtains the weighted information of the UAV according to the local observation and the information weight, inputs the weighted information and a hidden state of the UAV at a time step t−1 into an embedding layer, wherein the embedding layer converts input data into a continuous vector representation; an output of the embedding layer is used as an input of the Transformer-based decoder; and the input of the Transformer-based decoder is processed through a self-attention mechanism by the Transformer-based decoder to extract useful features therefrom, and the useful features are output as a hidden state and the local action-value function of the UAV at a time step t.

The hidden state refers to a compressed memory vector used for internal representation of a current environment/historical observation, which is an internal variable that cannot be directly observed externally but is used for decision-making or estimation.

In some embodiments, the UAV obtains the weighted information by receiving communication information from other UAVs or its own environment observation information as the local observation.

For example, the UAV may also obtain the weighted information through the attention mechanism. The processor generates an attention weight by calculating a similarity with the information weight, and then applies the attention weight to the local observation to obtain the weighted information.

In some embodiments of the present disclosure, through the Transformer-based decoder, combined with the local observation, the information weight, and a historical hidden state, complex temporal dependencies and multi-source information correlations of the UAV swarm can be effectively captured, enhancing accuracy of environment perception and coordinated decision-making, and significantly improving a coordinated control capability of the UAV in a dynamic multi-agent environment.

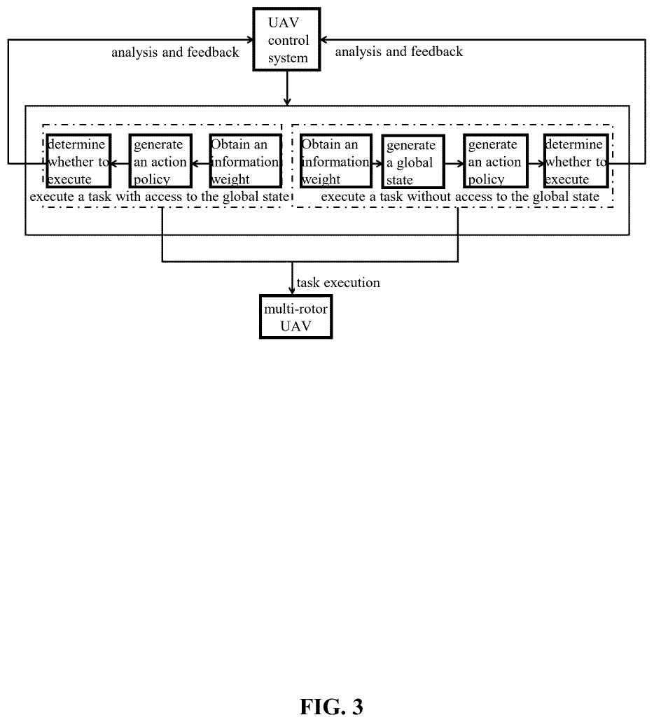

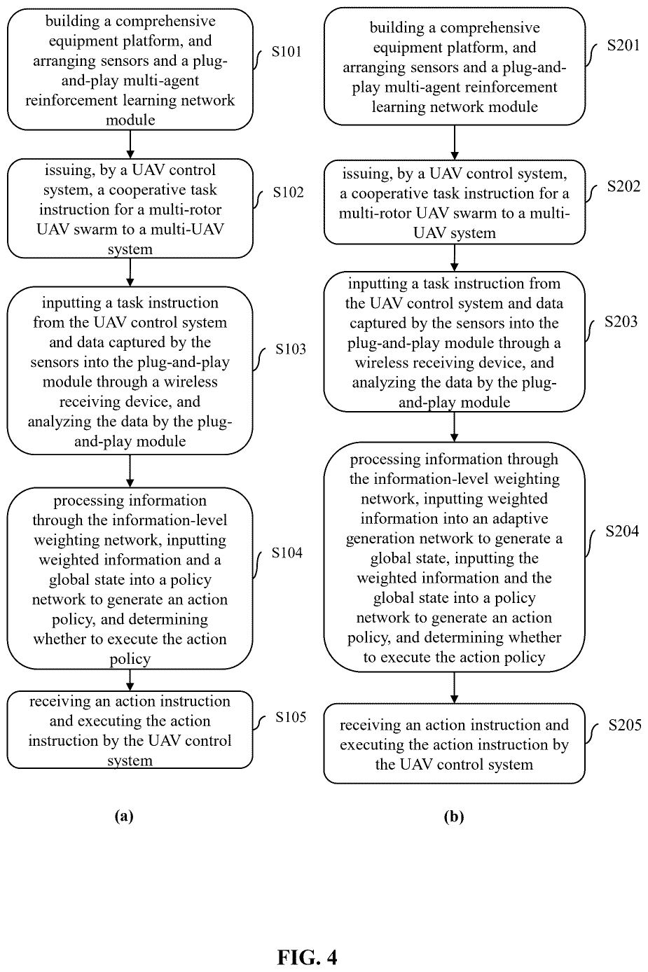

FIG. 3 is a system relationship diagram illustrating a plug-and-play module and a method according to some embodiments of the present disclosure. FIG. 4 is a flowchart illustrating an exemplary process of plug-and-play multi-UAV reinforcement learning for communication information completion according to some embodiments of the present disclosure. A multi-rotor UAV is a six-rotor industrial UAV with high stability and high scalability using an all-carbon fiber body. In this embodiment, the multi-rotor UAV is adopted as the UAV and implementation is carried out on a technical solution of the present disclosure.

The plug-and-play multi-UAV reinforcement learning module distinguishes two task execution situations for the multi-rotor UAV according to different execution policies, providing support for full-process logical analysis and diagnosis. Specific situations are as follows.
Situation 1: When the multi-rotor UAV needs to execute a task with access to the global state.
Situation 2: When the multi-rotor UAV needs to execute a task without access to the global state.

As shown in (a) of FIG. 4, a flowchart is provided for when the multi-rotor UAV needs to execute the task with access to the global state, and (b) of FIG. 4 is a flowchart for when the multi-rotor UAV needs to execute the task without access to the global state. When the multi-rotor UAV faces Situation 1, the process of executing a related task through the plug-and-play module and the multi-UAV reinforcement learning method include operations S101-S105.

In S101, a comprehensive equipment platform may be built, and sensors and a plug-and-play multi-agent reinforcement learning network module may be arranged.

In some embodiments, the comprehensive equipment platform includes a UAV control system. The plug-and-play multi-UAV reinforcement learning network module is for communication information completion. The plug-and-play multi-agent reinforcement learning network module includes the plug-and-play multi-UAV reinforcement learning network module.

In S102, the UAV control system issues a cooperative task instruction for the multi-rotor UAV swarm to the multi-UAV system.

In S103, a task instruction from the UAV control system and data captured by the sensors may be input into the plug-and-play module through a wireless receiving device, and the data may be analyzed by the plug-and-play module.

In S104, information may be processed through the information-level weighting network, the weighted information and the global state may be input into the policy network to generate an action policy, and whether to execute the action policy may be determined.

In some embodiments, the processor processes all input information through the information-level weighting network. The processor inputs the processed data and the global state of the system into the policy network of the UAV, determines a current action of the multi-rotor UAV swarm according to a policy function, and sends the action policy to the UAV control system.

In S105, the UAV control system receives an action instruction and executes the action instruction.

The UAV control system evaluates and analyzes the action policy sent by the plug-and-play module. If a current execution action of the multi-rotor UAV swarm meets a requirement of the task instruction issued by the UAV control system, the UAV control system allows the multi-rotor UAV swarm to execute the current action by default. If the current execution action of the multi-rotor UAV swarm does not meet the requirement of the task instruction issued by the UAV control system, the UAV control system sends an instruction to stop the current action of the multi-rotor UAV swarm, and requires the reinforcement learning network module to recollect all data and repeat operations S103 to S105 until the execution action of the multi-rotor UAV swarm meets the requirement of the task instruction issued by the UAV control system, then the process is stopped.

When the multi-rotor UAV faces Situation 2, the process of executing a related task through the plug-and-play module and the multi-UAV reinforcement learning method include operations S201-S205.

In S201, a comprehensive equipment platform may be built, and sensors and a plug-and-play multi-agent reinforcement learning network module may be arranged.

The comprehensive equipment platform includes a UAV control system. The plug-and-play multi-UAV reinforcement learning network module is for communication information completion. The plug-and-play multi-agent reinforcement learning network module includes the plug-and-play multi-UAV reinforcement learning network module.

In S202, the UAV control system may issue a cooperative task instruction for the multi-rotor UAV swarm to the multi-UAV system.

In S203, the task instruction from the UAV control system and data captured by the sensors may be input into the plug-and-play module through a wireless receiving device, and the data may be analyzed by the plug-and-play module.

The data analyzed by the plug-and-play module may include a current situation.

In S204, information may be processed through the information-level weighting network, the weighted information may be input into the adaptive generation network to generate a global state, the weighted information and the global state may be input into the policy network to generate an action policy, and whether to execute the action policy may be determined.

In some embodiments, the processor processes all input information through the information-level weighting network. The processor inputs the processed data and the information-level weight into the adaptive generation network. The processor performs information completion through the adaptive generation network and generates a current global state of the multi-rotor UAV swarm. The processor inputs the generated global state and the input information into the policy network of the UAV, determines a current action of the multi-rotor UAV swarm according to the policy function, and sends the action policy to the UAV control system.

In S205, the UAV control system receives the action instruction and executes the action instruction.

In some embodiments, the UAV control system evaluates and analyzes the action policy sent by the plug-and-play module. If a current execution action of the multi-rotor UAV swarm meets a requirement of the task instruction issued by the UAV control system, the UAV control system allows the multi-rotor UAV swarm to execute the current action by default. If the current execution action of the multi-rotor UAV swarm does not meet the requirement of the task instruction issued by the UAV control system, the UAV control system sends an instruction to stop the current action of the multi-rotor UAV swarm, and requires the reinforcement learning network module to recollect all data and repeat operations S203 to S205 until the execution action of the multi-rotor UAV swarm meets the requirement of the task instruction issued by the UAV control system, and then the process is stopped.

In some embodiments, a system for coordinated control of a UAV swarm based on communication information completion is provided, including: an information-level weighting network configured to process a local observation of each UAV and information of other UAVs to generate an information weight; an adaptive generation network including an information completion network and a global discriminator network, wherein the information completion network is connected to the information-level weighting network and generates a global state through an encoder-decoder architecture, and the global discriminator network is configured to determine an authenticity of the global state; a mixing network configured to integrate local action-value functions of UAVs and generate a global action-value function through an additive structure; a Transformer-based decoder configured to calculate a local action-value function of each UAV based on the local observation and the information weight in a distributed execution phase; a policy network configured to generate a final execution action according to the local action-value functions and coordinated decision-making; a loss function module including a first loss function and a generative adversarial network loss function, configured to update parameters of the mixing network, the adaptive generation network, and the information-level weighting network; a communication module configured to transmit weighted information and decision information between the UAVs; and an environment interaction module configured to simulate an interaction process between the UAVs and the environment and collect a reward signal.

The system for coordinated control of the UAV swarm refers to an integrated platform composed of a plurality of UAVs and related hardware, software, and communication mechanisms, aimed at achieving cooperative work among the UAVs to complete complex tasks.

The decision information refers to an action selection or an instruction made by the UAV or the UAV swarm according to the policy network and a current state.

More descriptions may be found in the related descriptions above.

The system for coordinated control of the UAV swarm in some embodiments of the present disclosure intelligently processes information and generates a weight through the information-level weighting network, and cooperates with the adaptive generation network to ensure accuracy and robustness of the global state, effectively overcoming limitations of local observation. The Transformer-based decoder significantly improves adaptability of decision-making of each UAV, achieves a higher task success rate and lower decision latency, and significantly enhances robustness of the system to local information loss, thereby improving overall task efficiency and safety.

One or more embodiments of the present disclosure have the following advantages.
(1) Achieve completion of communication information and reduce system dependence on access to the global state: for multi-UAV coordinated control, a plug-and-play module is configured to combine a generation network with a communication module of multi-UAV reinforcement learning, allowing the UAV to use a weighted local observation to generate the global state and use the global state and a learned communication weight to make coordinated decision-making, thereby reducing system dependence on access to the global state.
(2) Achieve information-level communication modeling and reduce computational requirements associated with joint training of the communication and the policy networks: the plug-and-play module can be pre-trained and seamlessly integrated into a plurality of MARL algorithms. By fusing a generative model loss function, training of the communication module is decoupled from a sparse reinforcement learning reward, thereby improving efficiency of a learning process of the policy network.
(3) The plug-and-play multi-UAV reinforcement learning method for communication information completion in the present disclosure designs a flexible structure to separate communication and policy training, thereby improving computational efficiency and effectively bridging a gap between centralized training and distributed execution.
(4) The present disclosure introduces the information-level weighting network in the centralized training phase, and calculates the information weights between UAVs based on the local observation of each UAV and observation information of other UAVs, thereby effectively capturing information correlation between the UAVs. The technical means enhances information exchange and cooperation capabilities between the UAVs and overcomes a problem of low accuracy of a communication model in a traditional manner.
(5) The present disclosure introduces a generative adversarial network, which can process global information in the centralized training phase, while the distributed execution phase only relies on the local observation and the communication information, thereby effectively narrowing a gap between training and execution. The technical means improves flexibility and scalability of the system and solves a limitation of centralized training relying on global information in the traditional manner.

If the above functions are implemented in a form of a software function unit and sold or used as an independent product, the functions may be stored in a computer-readable storage medium. Based on such an understanding, the technical solution of the present disclosure essentially, or the part contributing to the prior art, or a part of the technical solution may be implemented in a form of a software product. The computer software product is stored in a storage medium and includes several instructions for instructing a computer device (which may be a personal computer, a server, or a network device) to perform all or some of the operations of the methods described in the embodiments of the present disclosure. The above storage medium includes: a U disk, a removable hard disk, a read-only memory (ROM), a random access memory (RAM), a magnetic disk, an optical disk, or various media that may store program codes.

It should be noted that the above descriptions are merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. Therefore, the protection scope of the present disclosure shall be subject to the protection scope of the claims.

1. A method for coordinated control of an unmanned aerial vehicle (UAV) swarm based on communication information completion, wherein the method comprises:
step S1: obtaining, by each UAV, a local observation of the UAV from an environment, wherein the local observation is obtained in real time through a sensor disposed on the UAV;
step S2: in a centralized training phase, obtaining an information weight based on the local observation through an information-level weighting network;
obtaining weighted information of each UAV based on the information weight;
generating a global state through an adaptive generation network based on the weighted information of each UAV;
obtaining a global action-value function by integrating a local action-value function of each UAV through a mixing network based on the global state and the local action-value function of the UAV; wherein the local action-value function is calculated by each UAV based on the local observation through an independent Q-network;
the UAV swarm interacting with the environment to obtain a reward based on the global action-value function;
updating a parameter of the mixing network based on the reward through a first loss function;
updating a parameter of the adaptive generation network and a parameter of the information-level weighting network based on the information weight, the local observation, and the global state by a generative adversarial network loss function;
step S3: re-obtaining an information weight according to an updated information-level weighting network, and transmitting the information weight to each UAV; and
step S4: in a distributed execution phase, obtaining, by each UAV, the local action-value function of the UAV based on the local observation and the information weight through a Transformer-based decoder, and performing coordinated decision-making based on the local action-value function through a policy network to guide the UAV swarm to execute a corresponding action.

2. The method of claim 1, wherein the method further comprises:
generating adjusted flight parameters based on action execution of the UAV swarm and a feedback signal of the sensor;
generating a control signal through the policy network based on the adjusted flight parameters;
instructing the UAV swarm to move based on the adjusted flight parameters through the control signal;
when an obstacle is detected, instructing the UAV swarm through the control signal to generate an updated flight trajectory and an updated flight speed based on a relative position and distance information of the obstacle fed back by the sensor; and
controlling the UAV swarm to move to avoid the obstacle based on the updated flight trajectory and the updated flight speed.

3. The method of claim 1, wherein the obtaining an information weight based on the local observation through an information-level weighting network includes:
performing positional encoding on a local observation
$${o}_{t}^{i}$$
of a UAV i and information
$${m}_{t}^{- i}$$
obtained from other UAVs, converting the local observation
$${o}_{t}^{i}$$
of the UAV i and the information
$${m}_{t}^{- i}$$
into vector representations containing positional information to obtain position-encoded vectors;
performing repetition processing on the position-encoded vectors, converting the position-encoded vectors into an input format for an attention mechanism including queries, keys, and values, wherein after repetition processing a position-encoded vector of the local observation
$${o}_{t}^{i}$$
of the UAV i by a multi-layer perceptron (MLP), a query vector
$${Q}_{t}^{i}$$
is generated, and after processing the information
$${m}_{t}^{- i}$$
obtained from the other UAVs, a key vector
$${K}_{t}^{i}$$
and a value vector
$${V}_{t}^{i}$$
are generated; and
calculating a dot product of the query vector
$${Q}_{t}^{i}$$
and the key vector
$${K}_{t}^{i}$$
to obtain an attention score, applying a softmax function to the attention score to perform normalization processing, thereby obtaining information weights between UAVs through a formula as follows:
$${W}_{t}^{i} = σ ( {MLP}_{Q , K , V} ( soft max \frac{{Q}_{t}^{i} {K}_{t}^{{i}^{T}}}{\sqrt{d}} ) {V}_{t}^{i} ) )$$
$${Q}_{t}^{i} = M L {P}_{Q , K , V} ( {\underbrace{[ {o}_{t}^{i} , … … , {o}_{t}^{i} ]}}_{m} )$$
$${K}_{t}^{i} , {V}_{t}^{i} = M L {P}_{Q , K , V} ( [ {M}_{t} ] )$$
wherein Mₜ represents a set of local observations of all UAVs at a time t,
$${W}_{t}^{i}$$
represents an information weight of the UAV i at the time t, d represents a dimension of the query vector and the key vector, σ represents a ReLU activation function, and m represents a count of repetition processing times.

4. The method of claim 1, wherein the obtaining an information weight based on the local observation through an information-level weighting network further includes:
monitoring a computing resource state of each UAV; and
obtaining the information weight through the information-level weighting network based on the computing resource state and the local observation.

5. The method of claim 4, wherein the method further comprises:
in response to detecting that a first UAV has a computational load greater than an upper threshold:
identifying a second UAV having a computational load less than a lower threshold;
determining a task migration policy based on a task type and a communication state;
migrating a target task of the first UAV to the second UAV for execution based on the task migration policy; and
returning a task result to the first UAV after the second UAV completes the target task.

6. The method of claim 1, wherein the weighted information of each UAV is obtained based on the information weight through a following formula:
$${x}_{t}^{i} = ( 1 - {W}_{t}^{i} ) \cdot {M}_{t}^{i , - i} + {W}_{t}^{i} \cdot {ϵ}_{t} , {ϵ}_{t} ∼ 𝒩 ( 0 , I )$$
wherein
$${x}_{t}^{i}$$
represents weighted information of a UAV i at a time t,
$${W}_{t}^{i}$$
represents an information weight of the UAV i at the time t,
$${M}_{t}^{i , - i} = \{ {o}_{t}^{i} , {m}_{t}^{- i} \} ∈ {R}^{n \times l}$$
represents complete information obtained by the UAV i at the time t,
$${m}_{t}^{- i}$$
represents a set of local observations of the other UAVs excluding the UAV i at the time t, ϵₜ represents white noise, [symbol] (0, I) represents a normal distribution, and I represents an identity matrix.

7. The method of claim 1, wherein the adaptive generation network includes an information completion network and a global discriminator network, the information completion network is connected to an information weight network, and the information completion network adopts a U-Net architecture and follows an encoder-decoder architecture.

8. The method of claim 7, wherein the adaptive generation network further includes an environment feature extraction network;
the environment feature extraction network is connected to the information completion network, and adopts a structure combining a convolutional neural network (CNN) and an attention mechanism; and
the environment feature extraction network is configured to extract environment features at multiple levels from the weighted information of each UAV and update the global state, the environment features including a texture feature, an illumination feature, and a semantic feature.

9. The method of claim 8, wherein the method further comprises:
in response to a similarity between a current environment feature and a historical environment feature being lower than a preset threshold:
copying a current adaptive generation network to generate a model to be updated; and
training the model to be updated by a second UAV to obtain an updated adaptive generation network.

10. The method of claim 9, wherein the method further comprises:
establishing an environment knowledge base, the environment knowledge base being configured to store a mapping relationship between historical environment features and parameters of the adaptive generation network; and
in response to the similarity between the current environment feature and the historical environment feature being higher than the preset threshold, retrieving, from the environment knowledge base, a parameter of the adaptive generation network that satisfies a preset condition with the current environment feature.

11. The method of claim 10, wherein the training the model to be updated includes:
determining a statistical correlation between a plurality of historical environment features and corresponding parameters of the adaptive generation network based on the environment knowledge base; and
guiding a parameter initialization of the model to be updated based on the statistical correlation.

12. The method of claim 1, wherein the generating a global state through an adaptive generation network based on the weighted information of each UAV includes:
$${x}_{t}^{i}$$
inputting downsampled data into an encoder and a decoder of an information completion network, and outputting the global state:
$${s}_{t} = G ( {x}_{t}^{1} , {x}_{t}^{2} … , {x}_{t}^{n} )$$
wherein sₜ represents a global state at a time t generated by the information completion network, and n represents a count of UAVs in the UAV swarm.

13. The method of claim 1, wherein the obtaining a global action-value function by integrating a local action-value function of each UAV through a mixing network based on the global state and the local action-value function of the UAV includes:
determining weights of local action-value functions of all UAVs using the global state by learning a mixing network Qₜₒₜ(τ, a, m, s; θ) and utilizing an additive structure of a QMIX network, and synthesizing the local action-value function of each UAV into the global action-value function through the weights of the local action-value functions.

14. The method of claim 1, wherein the first loss function is:
$${y}_{i}^{tot} = r + γ {max}_{{a}_{t + 1}} {Q}_{tot} ( {τ}_{t + 1} , {α}_{t + 1} , {m}_{t + 1} , {s}_{t + 1} ; {θ}^{-} )$$
wherein [symbol] (θ) represents the first loss function, n represents a count of UAVs, yᵢ^{tot} represents a target Q-value of a UAV i, Qₜₒₜ(τₜ, αₜ, m, sₜ; θ) represents a mixing network Q-value at a time t, Tt represents a historical observation at the time t, αₜ represents an action at the time t, mₜ represents information of the UAV swarm at the time t, sₜ represents a global state at the time t, θ represents the parameter of the mixing network, r represents the reward obtained by the UAV swarm interacting with the environment, γ represents a discount factor, maxₐ_{ₜ₊₁} represents a Qₜₒₜ value of a maximized action αₜ₊₁.

15. The method of claim 1, wherein the generative adversarial network loss function is:
$${min}_{D} {max}_{G} \{ - {E}_{o ∼ O} {ℒ}_{M S E} - {E}_{s ∼ S} log D ( {s}_{t} ) - α {E}_{o ∼ O} log ( 1 - D ( {s}_{t} ) ) \}$$
$${ℒ}_{M S E} = {‖ O ( {s}_{t} ) - {o}_{t} ‖}^{2}$$
wherein [symbol] _{MSE} represents a second loss function, ∥·∥ represents a Euclidean norm, oₜ represents an actual local observation, O(sₜ) represents a local observation predicted according to the global state, D represents a global discriminator network in the adaptive generation network, G represents an information completion network in the adaptive generation network, E represents calculating an expectation, o~O represents sampling o from a distribution O, s~S represents sampling s from a distribution S, sₜ represents a global state at a time t, D(sₜ) represents a probability of determining whether the global state sₜ represents true output by inputting the global state sₜ into the global discriminator network, oₜ represents a local observation at the time t, and α represents a weight hyperparameter.

16. The method of claim 1, wherein the obtaining, by each UAV, the local action-value function of the UAV based on the local observation and the information weight through a Transformer-based decoder includes:
obtaining the weighted information of the UAV according to the local observation and the information weight; inputting the weighted information and a hidden state of the UAV at a time step t−1 into an embedding layer, wherein the embedding layer converts input data into a continuous vector representation; an output of the embedding layer is used as an input of the Transformer-based decoder; and the input of the Transformer-based decoder is processed through a self-attention mechanism by the Transformer-based decoder to extract useful features therefrom, and the useful features are output as a hidden state of the UAV at a time step t and the local action-value function of the UAV.

17. A system for coordinated control of a UAV swarm based on communication information completion, comprising:
an information-level weighting network configured to process a local observation of each UAV and information of other UAVs to generate an information weight;
an adaptive generation network including an information completion network and a global discriminator network, wherein the information completion network is connected to the information-level weighting network and generates a global state through an encoder-decoder architecture, and the global discriminator network is configured to determine an authenticity of the global state;
a mixing network configured to integrate local action-value functions of UAVs and generate a global action-value function through an additive structure;
a Transformer-based decoder configured to calculate a local action-value function of each UAV based on the local observation and the information weight in a distributed execution phase;
a policy network configured to generate a final execution action according to the local action-value functions and coordinated decision-making;
a loss function module including a first loss function and a generative adversarial network loss function, configured to update parameters of the mixing network, the adaptive generation network, and the information-level weighting network;
a communication module configured to transmit weighted information and decision information between the UAVs; and
an environment interaction module configured to simulate an interaction process between the UAVs and the environment and collect a reward signal.
